(19) United States
(12) Patent Application Publication
(10) Pub. No.: US 2013/0316228 A1
(43) Pub. Date: Nov. 28, 2013

(54) SODIUM ION CONDUCTOR BASED ON SODIUM TITANATE

(71) Applicants: Andre Moc, Grossschoenau (DE); Ulrich Eisele, Stuttgart (DE); Alan Logeat, Stuttgart (DE)

(72) Inventors: Andre Moc, Grossschoenau (DE); Ulrich Eisele, Stuttgart (DE); Alan Logeat, Stuttgart (DE)

(21) Appl. No.: 13/992,467

(22) PCT Filed: Oct. 20, 2011
(86) PCT No.: PCT/EP2011/068286

§ 371 Date: Aug. 14, 2013

(30) Foreign Application Priority Data
Dec. 9, 2010 (DE) 10 2010 062 726.7

(51) Int. Cl. H01M 10/0562; H01M 10/054

(52) U.S. Cl. CPC H01M 10/0562; H01M 10/054
USPC 429/188; 423/598; 252/62.2

(57) ABSTRACT

A sodium ion conductor is described which includes a sodium titanate. Moreover, a also described are a galvanic cell, a sensor having this type of sodium ion conductor (3, 4a, 4b), and a production method for this type of sodium ion conductor.

### FIELD OF THE INVENTION

The present invention relates to a sodium ion conductor, a galvanic cell, a sensor having this type of sodium ion conductor, and a manufacturing method for this type of sodium ion conductor.

### BACKGROUND INFORMATION

Sodium-sulfur cells are customarily operated at a temperature (˜300° C.) at which sulfur and sodium are liquid in order to ensure sufficient conductivity and sufficient transport of sodium ions, as well as sufficient contact between the reactants (sulfur, sodium ions, and electrons). A sulfur-graphite composite is usually used as the cathode material for these types of high-temperature sodium-sulfur cells.

However, sodium-sulfur cells having a sulfur-graphite cathode cannot be operated at room temperature, since the sodium ion conductivity of solid sulfur and graphite is not sufficient. In addition, an irreversible loss of capacity may occur due to phase transition when this type of sodium-sulfur cell is repeatedly charged and discharged.

In sodium-sulfur cells, the use of liquid electrolytes may result in the sodium anode reacting with the electrolyte, the electrolytic solvent, or polysulfides, and corroding. In addition, sodium dendrites may form between the electrodes upon repeated charging and discharging, and may short-circuit the cell.

### SUMMARY

The subject matter of the present invention is a sodium ion conductor which includes a sodium titanate.

Within the scope of the present invention, a sodium titanate may be understood to mean a pure sodium titanate as well as a sodium titanate mixed oxide or a doped sodium titanate which includes one or multiple foreign atoms (metal cations other than sodium and titanium), in particular foreign atom oxides, in particular when the total number of foreign atoms is >0% to ≦10%, for example >0% to ≦1%, relative to the number of titanium atoms.

The group of sodium titanates, for example Na₂Ti₃O₇, forms a layered TiO₆ octahedral structure in which sodium ions occupy the sites between the octahedral layers. It has been found that the sodium ions situated between the octahedral layers have good ion exchange capability and good sodium ion conductivity. Sodium titanates may advantageously have good sodium ion conductivity, even at room temperature. This, in turn, has the advantage that sodium titanates may be used as a solid electrolyte in low-temperature/(room temperature) sodium cells and other applications such as sensors. Thus, liquid electrolytes and electrolytes which may possibly be flammable may be dispensed with, and long-term stability and reliability may be increased.

Furthermore, depending on the mixed oxide composition, doping, or synthesis conditions, sodium titanates may advantageously additionally function as electron conductors, so that additives for increasing the electrical conductivity may be dispensed with and a high overall energy density may be achieved.

Within the meaning of the present invention, in particular a material may be understood to be conductive for sodium ions which has a sodium ion conductivity of ≧1·10⁻⁶ S/cm at 25° C. Within the meaning of the present invention, “nonconductive for electrons” may be understood to mean a material which has a sodium ion conductivity of <1·10⁻⁸ S/cm at 25° C.

in addition, the raw materials for preparing sodium titanates may advantageously be obtained at favorable prices and synthesized using energy-saving low-temperature processes, for example hydrothermal synthesis.

Within the scope of one specific embodiment, the sodium titanate contains tetravalent and/or trivalent titanium. Sodium titanates of tetravalent titanium, i.e., sodium titanates containing only titanium(IV), not titanium(III), have proven to be particularly advantageous as solid electrolytes which are conductive for sodium ions and nonconductive for electrons. Sodium titanates containing trivalent titanium may advantageously have a higher electron conductivity than sodium titanates containing only tetravalent titanium. Therefore, sodium titanates containing trivalent titanium are particularly suited as solid electrolytes which are conductive for sodium ions and electrons.

For a sodium titanate mixed oxide or a doped sodium titanate, the sodium ion conductivity and electron conductivity may advantageously be set by adjusting the type and quantity of foreign atoms. In particular, the sodium titanate may be a sodium titanate mixed oxide which contains one or multiple foreign atom oxides selected from the group composed of sodium oxide, lithium oxide, magnesium oxide, calcium oxide, barium oxide, zinc oxide, iron oxide, aluminum oxide, gallium oxide, zirconium oxide, manganese oxide, silicon oxide, niobium oxide, tantalum oxide, and bismuth oxide, or the sodium titanate may be doped with one or multiple foreign atoms selected from the group composed of sodium, lithium, magnesium, calcium, barium, zinc, iron, aluminum, gallium, zirconium, manganese, silicon, niobium, tantalum, and bismuth. For example, the sodium titanate mixed oxide may contain one or multiple foreign atom oxides selected from the group composed of sodium oxide, lithium oxide, magnesium oxide, calcium oxide, barium oxide, manganese(II) oxide, zinc oxide, iron(II) oxide, aluminum oxide, gallium oxide, niobium(III) oxide, manganese(III) oxide, iron(III) oxide, zirconium oxide, manganese(IV) oxide, silicon oxide, niobitim(V) oxide, tantalum oxide, and bismuth(V) oxide, or the sodium titanate may be doped with one or multiple foreign atoms selected from the group composed of sodium, lithium, magnesium, calcium, barium, manganese(II), zinc, iron(II), aluminum, gallium, niobium(III), manganese(III), iron(III), zirconium, manganese(IV), silicon, niobium(V), tantalum, and bismuth(V).

Titanium sites in the sodium titanate are preferably occupied by foreign atoms instead of by titanium. For example, titanium(III) sites may be occupied by aluminum, gallium, niobium(III), manganese(III), and/or iron(III), and/or by magnesium, calcium, barium, manganese(III), zinc, and/or iron(II) and zirconium, manganese(IV), and/or silicon, and/or by sodium and/or lithium and niobium(V), tantalum, and/or bismuth(V). Titanium(IV) sites may be occupied, for example, by zirconium, manganese(IV), and/or silicon, and/or by aluminum, gallium, niobium(III), manganese(III), and/or iron(III) and niobium(V), tantalum, and/or bismuth(V).

Within the scope of one embodiment, the sodium ion conductor includes a sodium titanate which contains trivalent titanium. In particular, the sodium ion conductor may be composed of a sodium titanate which contains trivalent titanium. Sodium titanates which contain trivalent titanium have proven to be advantageous as solid electrolytes which are conductive for sodium ions and electrons.

Within the scope of another specific embodiment, the sodium ion conductor includes a sodium titanate of general formula (1):

Na₂Ti^{IV}ₙ₋ₓTi^{III}ₓO_{2n+1-x/2}:MO,

where 2≦n≦10 and 0≦x≦n, and MO stands for one or multiple foreign atom oxides selected from the group composed of Na₂O, Li₂O, MgO, CaO, BaO, MnO, ZnO, FeO, Ti₂O₃, Al₂O₃, Ga₂O₃, Nb₂O₃, Mn₂O₃, Fe₂O₃, ZrO₂, MnO₂, SiO₂, Nb₂O₅, Ta₂O₅, and Bi₂O₅, or for no foreign atom oxide, i.e., Na₂Ti^{IV}ₙ₋ₓTi^{III}ₓO_{2n+1-x/2}, where 2≦n≦10 and 0≦x≦n. In particular, the sodium ion conductor may be composed of this type of sodium titanate, Such sodium titanates have proven to be advantageous as solid electrolytes which are conductive for sodium ions and electrons.

Within the scope of another embodiment, the sodium ion conductor includes a sodium titanate of tetravalent titanium. In particular, the sodium ion conductor may be composed of a sodium titanate of tetravalent titanium. Sodium titanates of tetravalent titanium have proven to be advantageous as solid electrolytes which are conductive for sodium ions and nonconductive for electrons.

Within the scope of another specific embodiment, the sodium ion conductor includes a sodium titanate of general formula (2):

Na₂Ti^{IV}ₙO₂ₙ₊₁:MO,

where 2≦n≦10 and MO stands for one or multiple foreign atom oxides selected from the group composed of Na₂O, Li₂O, MgO, CaO, BaO, MnO, ZnO, FeO, Ti₂O₃, Al₂O₃, Ga₂O₃, Nb₂O₃, Mn₂O₃, Fe₂O₃, ZrO₂, MnO₂, SiO₂, Nb₂O₅, Ta₂O₅, and Bi₂O₅, or for no foreign atom oxide, i.e., Na₂Ti^{IV}ₙO₂ₙ₊₁, where 2≦n≦10. In particular, the sodium ion conductor may be composed of this type of sodium titanate. Sodium titanates general formula (2) have proven to be advantageous as solid electrolytes which are conductive for sodium ions and nonconductive for electrons.

Within the meaning of the present invention, the colon (:) in formulas (1) and (2) may be understood in particular to mean that in the empirical formula, the titanium oxide may be partially replaced by one or multiple foreign atom oxides(mixed oxide/doping).

Within the scope of another specific embodiment, the sodium ion conductor also includes β-aluminum oxide, in particular textured β-aluminum oxide. Textured β-aluminum oxide may be understood in particular to mean a β-aluminum oxide which has a directional structure, for example produced by an electrical and/or magnetic field, in particular for increasing the sodium ion conductivity.

Within the scope of another specific embodiment, the sodium ion conductor is a composite which contains sodium titanate, for example of tetravalent titanium, in particular of general formula (2), and β-aluminum oxide.

A further subject matter of the present invention relates to a galvanic cell, in particular a sodium cell, for example a sodium-chalcogen cell, for example a sodium-sulfur cell or a sodium-oxygen cell, Which includes a sodium ion conductor according to the present invention. Sufficient sodium ion conductivity may be ensured, even at room temperature. Thus, a solid-based low termperature/(room temperature) cell having improved long-term stability and reliability may advantageously be provided.

Within the scope of another specific embodiment, the cell includes the sodium ion conductor as a solid electrolyte. High-termperature conditions and liquid electrolytes may thus advantageously be dispensed with.

Within the scope of another specific embodiment, the cathode (positive electrode) of the cell includes a sodium ion conductor according to the present invention, in particular a sodium ion conductor according to the present invention which includes a sodium titanate containing trivalent titanium. Using this type of sodium ion conductor as cathode material has the advantage that the sodium ion conductor is additionally conductive for electrons, and therefore at the same time may function as a current conductor. Further additives for increasing the electrical conductivity may thus be dispensed with, and the overall energy density of the cell may be optimized.

Within the scope of another specific embodiment, the anode (negative electrode) and the cathode of the cell are separated by a sodium ion conductor according to the present invention, in particular a sodium ion conductor which is conductive for sodium ions and nonconductive for electrons, for example a sodium ion conductor according to the present invention which includes a sodium titanate of tetravalent titanium. A separation of the anode and cathode by this type of sodium ion conductor, which in particular may have a low electron conductivity, has the advantage that short circuits may thus be avoided.

Within the scope of another specific embodiment, the cathode of the cell has at least one conducting element. The conducting element may in particular include or be composed of a sodium ion conductor according to the present invention, in particular a sodium ion conductor according to the present invention which is conductive for sodium ions and electrons, for example a sodium ion conductor according to the present invention having a sodium titanate which contains trivalent titanium. Sodium ions as well as electrons may advantageously be transported via this type of conducting element.

The conducting element may be designed, for example, in the form of a porous, for example sponge-like, body or in the form of a wire or fiber mesh, for example made of nanowires nanofibers. Nanowires or nanofibers may be understood in particular to mean wires or fibers having an average diameter of ≦500 nm, for example ≦100 nm. However, it is likewise possible for the cathode to include a plurality of conducting elements which are rod-like, plate-like, or grid-like, for example.

One section of the conducting element or the conducting elements preferably contacts the sodium ion conductor which separates the anode and the cathode, and another section of the conducting element or the conducting elements preferably contacts a cathode current collector. Good conduction of sodium ions and electrons may be ensured as a result of the conducting elements. For example, one section of a conducting element designed in the form of a porous body or wire or fiber mesh may contact the sodium ion conductor which separates the anode and the cathode, and another section of the conducting element designed in the form of a porous body or wire or fiber mesh may contact the cathode current collector.

In particular, the cathode may include a plurality of conducting elements composed of sodium ion conductors according to the present invention, one section of which in each case contacts the sodium ion conductor which separates the anode and the cathode, and another section of which contacts the cathode current collector. Particularly good conduction of sodium ions and electrons may be ensured in this way. For example, the cathode may include a plurality of flat or arched plate-shaped or grid-shaped conducting elements situated at a distance from one another, which in each case on the one hand contact the sodium ion conductor which separates the anode and the cathode, and on the other hand contact the cathode current collector. The conducting elements may be situated essentially in parallel to one another. For example, the conducting elements may be situated with respect to one another similarly as for the slats of a Venetian blind. The conducting elements may be situated essentially vertically with respect to the sodium ion conductor which separates the anode and the cathode, as well as with respect to the cathode current collector.

Alternatively or additionally, structures may be provided on the conducting element which include or are composed of a sodium ion conductor according to the present invention, in particular a sodium ion conductor according to the present invention which includes a sodium titanate containing trivalent titanium. As a result of the structures, the surface of the conducting element, and thus the surface area available for the sodium-chalcogen redox reaction, may advantageously be enlarged. The structures may be, for example, structures in the range of several microns or nanometers.

The conducting elements and structures may be formed from the same or also from different sodium ion conductors, in particular sodium ion conductors which are conductive for sodium ions and electrons. In particular, the conducting elements and structures may be formed from the same sodium ion conductor, in particular sodium ion conductors which are conductive for sodium ions and electrons.

The structures are preferably formed by sodium titanate crystals which are needle-shaped, for example. These types of structures may be provided on the conducting element by hydrothermal synthesis, for example.

The anode may in particular be made of metallic sodium or a sodium alloy, in particular metallic sodium. A high maximum voltage may be advantageously achieved in this way.

The chalcogen may in particular be sulfur and/or oxygen, in particular sulfur. The sodium ion conductor of the cathode, the conducting elements, and the structures provided on the conducting elements may in particular be infiltrated with the chalcogen.

With regard to further features and advantages of the galvanic cell according to the present invention, explicit reference is hereby made to the explanations in conjunction with the sodium ion conductor according to the present invention, the sensor according to the present invention, the method according to the present invention, the use according to the present invention, and the description of the figures.

A further subject matter of the present invention relates to a sensor, for example a carbon dioxide, nitrogen oxides, in particular nitrogen dioxide, alcohol, aldehyde, and/or carboxylic acid sensor which includes a sodium ion conductor according to the present invention.

The use is not limited to the low temperature (room temperature) Na—S battery. Use in sensor applications which require sodium ion conductivity, or sodium ion conductivity and electron conductivity, would also be conceivable.

With regard to further features and advantages of the sensor according to the present invention, explicit reference is hereby made to the explanations in conjunction with the sodium ion conductor according to the present invention, the galvanic cell according to the present invention, the method according to the present invention, the use according to the present invention, and the description of the figures.

A further subject matter of the present invention relates to a method for producing a sodium ion conductor according to the present invention, including method step a): preparing a sodium titanate by hydrothermal synthesis. For example, the sodium titanate provided in method step a) may be at least partially crystalline or even essentially completely crystalline. For example, the sodium titanate may be formed in needle-shaped crystals.

The conductivity of sodium ions and electrons and/or the crystal structure of the sodium titanate may be adjusted in method step a), for example, via the temperature, the pressure, the duration, and/or the solvent of the hydrothermal synthesis.

Within the scope of another specific embodiment, in method step a) metallic titanium and/or a titanium-containing metal mixture or metal alloys, and/or one or multiple titanium compound(s), for example titanium oxide and/or titanium nitride, is/are reacted in an aqueous sodium hydroxide solution having a concentration, for example, in a range of ≧5 mol/L to ≦15 mol/L, for example at a temperature in a range of ≧130° C. to ≦210° C.

The hydrothermal synthesis may be carried out in particular in an autoclave. The reaction time in method step a) may be from ≧1 h to <72 h, for example. The reaction product may subsequently be filtered off and optionally washed and dried.

Within the scope of another specific embodiment, the method also includes method step b): heating or sintering the obtained sodium titanatc, for example to or at a temperature in a range of ≧400° C. to ≦1100° C., in particular under reducing conditions, for example under a hydrogen-containing atmosphere. Tetravalent titanium may thus be at least partially converted into trivalent titanium. The electron conductivity of the sodium titanate may advantageously be increased and adjusted in this way.

In particular, a galvanic cell according to the present invention may be produced by the method according to the present invention. A conducting element may be produced from the sodium titanate prepared according to the present invention, and/or sodium titanate structures may be provided on a conducting element. For example, a conducting element may be initially formed, for example via a pressing process, from a sodium titanate prepared according to the present invention, and sodium titanate structures, in particular in crystalline form, may subsequently be provided on the conducting element via the method according to the present invention.

With regard to further features and advantages of the method according to the present invention, explicit reference is hereby made to the explanations in conjunction with the sodium ion conductor according to the present invention, the galvanic cell according to the present invention, the sensor according to the present invention, the use according to the present invention, and the description of the figures.

A further subject matter of the present invention relates to the use of a sodium titanate as a sodium ion conductor, in particular as a solid electrolyte which is conductive for sodium ions, for example as a solid electrolyte which is conductive for sodium ions and electrons, or as a solid electrolyte which is conductive for sodium ions and nonconductive for electrons.

With regard to further features and advantages of the use according to the present invention, explicit reference is hereby made to the explanations in conjunction with the sodium ion conductor according to the present invention, the galvanic cell according to the present invention, the sensor according to the present invention, the method according to the present invention, and the description of the figures.

### BRIEF DESCRIPTION OF THE DRAWINGS

FIG. 1 shows a schematic cross section of one specific embodiment of a sodium-chaleogen cell according to the present invention.

FIG. 2 shows an enlargement of the area marked in FIG. 1.

### DETAILED DESCRIPTION

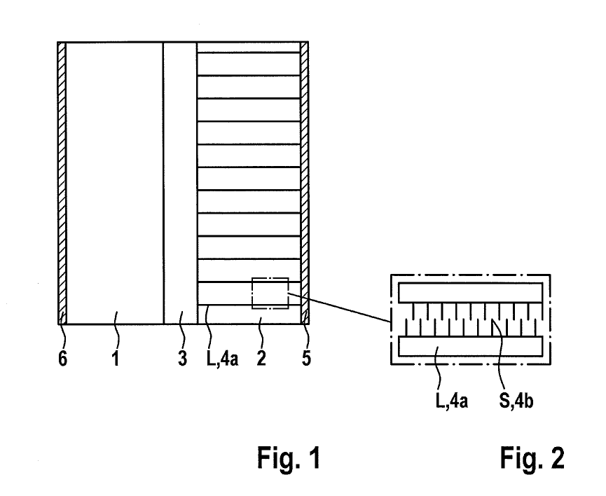

FIG. 1 shows that the sodium-chalcogen cell has an anode 1 containing sodium and a cathode 2 containing sulfur or oxygen. FIG. 1 further illustrates that anode 1 has an anode current collector 6, and cathode 2 has a cathode current collector 5, FIG. 1 shows in particular that anode 1 and cathode 2 are separated by a sodium ion conductor 3 which is conductive for sodium ions and nonconductive for electrons. This sodium ion conductor 3 may be made, for example, of polycrystalline β-aluminate, polycrystalline textured β-aluminate, a sodium titanate of tetravalent titanium, for example Na₂Ti^{IV}₂O₂ₙ₊₁, or a composite of β-aluminate and a sodium titanate of tetravalent titanium, for example Na₂Ti^{IV}₂O₂ₙ₊₁. FIG. 1 further illustrates that within the scope of this specific embodiment, cathode 2 includes a plurality of conducting elements L composed of a sodium ion conductor 4a which is conductive for sodium ions and electrons, one section of which in each case contacts sodium ion conductor 3 which separates anode 1 and cathode 2, and another section of which contacts cathode current collector 5.

FIG. 2 shows that within the scope of this specific embodiment, structures S composed of a solid electrolyte 4b which is conductive for sodium ions and electrons are provided on conducting elements L. These may be needle-shaped sodium titanate crystals, for example. These structures may be provided on conducting elements L with the aid of hydrothermal synthesis, for example. Conducting elements L and structures S may be composed, for example, of a sodium ion conductor which is conductive for sodium ions and electrons, and which includes a sodium titanate containing trivalent titanium, for example of general formula (1): Na₂Ti^{IV}ₙ₋ₓTi^{III}ₓO_{2n+1-x/2}, where 2≦n≦10 and 0≦x≦n.

1.-15. (canceled)

16. A sodium ion conductor which contains a sodium titanate.

17. The sodium ion conductor as recited in claim 16, wherein the sodium titanate includes at least one of tetravalent and trivalent titanium.

18. The sodium ion conductor as recited in claim 16, wherein the sodium ion conductor includes a sodium titanate of general formula (1):
Na₂Ti^{IV}ₙ₋ₓTi^{III}ₓO_{2n+1-x/2}:MO,
where 2≦n≦10 and 0≦x≦n, and MO stands for one or multiple foreign atom oxides selected from the group composed of Na₂O, Li₂O, MgO, CaO, BaO, MnO, ZnO, FeO, Ti₂O₃, Al₂O₃, Ga₂O₃, Nb₂O₃, Mn₂O₃, Fe₂O₃, ZrO₂, MnO₂, SiO₂, Nb₂O₅, Ta₂O₅, and Bi₂O₅, or for no foreign atom oxide.

19. The sodium ion conductor as recited in claim 16, wherein the sodium ion conductor includes a sodium titanate of general formula (2):
Na₂Ti^{IV}ₙO₂ₙ₊₁:MO,
where 2≦n≦10 and MO stands for one or multiple foreign atom oxides selected from the group composed of Na₂O, Li₂O, MgO, CaO, BaO, MnO, ZnO, FeO, Ti₂O₃, Al₂O₃, Ga₂O₃, Nb₂O₃, Mn₂O₃, Fe₂O₃, ZrO₂, MnO₂, SiO₂, Nb₂O₅, Ta₂O₅, and Bi₂O₅, or for no foreign atom oxide.

20. The sodium ion conductor as recited in claim 16, wherein the sodium ion conductor also includes β-aluminum oxide.

21. The sodium ion conductor as recited in claim 20, wherein the β-aluminum oxide includes a textured β-aluminum oxide.

22. The sodium ion conductor as recited in claim 16, wherein the sodium ion conductor is a composite which includes sodium titanate and β-aluminum oxide.

23. A galvanic cell, comprising:
a sodium ion conductor which contains a sodium titanate.

24. The galvanic cell as recited in claim 23, wherein the galvanic cell is a sodium-chalcogen cell corresponding to one of a sodium-sulfur cell and a sodium-oxygen cell

25. The galvanic cell as recited in claim 23, wherein the galvanic cell includes the sodium ion conductor as a solid electrolyte.

26. The galvanic cell as recited in claim 23, wherein a cathode of the galvanic cell includes the sodium ion conductor.

27. The galvanic cell as recited in claim 26, wherein the sodium titanate includes at least one of tetravalent and trivalent titanium.

28. The galvanic cell as recited in claim 23, wherein an anode and a cathode of the galvanic cell are separated by the sodium ion conductor.

29. The galvanic cell as recited in claim 28, wherein the sodium ion conductor includes a sodium titanate of general formula (2):
Na₂Ti^{IV}ₙO₂ₙ₊₁:MO,
where 2≦n≦10 and MO stands for one or multiple foreign atom oxides selected from the group composed of Na₂O, Li₂O, MgO, CaO, BaO, MnO, ZnO, FeO, Ti₂O₃, Al₂O₃, Ga₂O₃, Nb₂O₃, Mn₂O₃, Fe₂O₃, ZrO₂, MnO₂, SiO₂, Nb₂O₅, Ta₂O₅, and Bi₂O₅, or for no foreign atom oxide.

30. The galvanic cell as recited in claim 23, wherein a cathode of the galvanic cell includes at least one conducting element, and wherein at least one of:
the at least one conducting element includes the sodium ion conductor in which the sodium titanate includes at least one of tetravalent and trivalent titanium, and
structures are provided on the at least one conducting element that include the sodium ion conductor in which the sodium titanate includes at least one of tetravalent and trivalent titanium.

31. A sensor, comprising:
a sodium ion conductor which contains a sodium titanate.

32. A method for producing a sodium ion conductor which contains a sodium titanate, comprising:
preparing a sodium titanate by hydrothermal synthesis.

33. The method as recited in claim 32, wherein in the preparing step metallic titanium and/or a titanium-containing metal mixture or metal alloys, and/or one or multiple titanium compound(s), for example titanium oxide and/or titanium nitride, is/are reacted in an aqueous sodium hydroxide solution having a concentration, for example, in a range of ≧5 mol/L to ≦15 mol/L, for example at a temperature in a range of ≧130° C. to ≦210° C.

34. The method as recited in claim 32, further comprising:
heating the sodium titanate to a temperature in a range of ≧400° C. to ≦1100° C.

35. The method as recited in claim 34, wherein the heating is performed under reducing conditions.

36. The method as recited in claim 35, wherein the heating is performed under a hydrogen-containing atmosphere.
